(19) United States
(12) Patent Application Publication
(10) Pub. No.: US 2012/0249317 A1
(43) Pub. Date: Oct. 4, 2012

(54) BICYCLE SEAT COVER WITH WARNING APPARATUS

(76) Inventor: SHIUAN-SHENG WANG, TAIPEI CITY (TW)

(21) Appl. No.: 13/405,394

(22) Filed: Feb. 27, 2012

(30) Foreign Application Priority Data
Mar. 29, 2011 (TW) 100205486

(51) Int. Cl. B62J 6/00

(52) U.S. Cl. 340/432

(57) ABSTRACT

The present invention relates to an improving bicycle warning assembly, which mainly includes a bicycle seat cover connecting with electricity generate modules and an LED module with LEDs, which are mounted in back side direction for warning those behind. When a user is riding a bicycle, he sets on the seat cover and his weight compresses the electricity generate module back and forth that can generate electricity for LEDs to lighten without an extra battery and obtains warning purpose.

### BACKGROUND OF THE INVENTION

Because of change of life style, to ride a bicycle on road becomes a popular leisure activity. It is to be found that safety of riding a bicycle is more and more important than ever. We all know that to provide a warning apparatus on back side of the bicycle is necessary. In this time, the known method is to connect a traditional warning light mechanically with the bicycle and to use a battery as a power supply. In this way, it is somehow inconvenience in connecting procedure with such warning lights. Moreover, the traditional warning light spends large energy. The energy of battery in use of the bicycle will run out soon and the light loses its warning purpose at all. Hence, the known method should be improved.

### SUMMARY OF THE INVENTION

The present invention is aimed to design a kind of warning apparatus for bicycle which can overcome the drawbacks mentioned in prior art. That is, the present invention is related to an improving warning assembly for bicycle use, which mainly includes a bicycle seat cover connecting with at least one electricity generate module and an LED module with at least one LED, which is mounted at back side direction. When a user is riding a bicycle, he sits on the seat cover and his weight compresses the electricity generate module back and forth that can generate electricity for LED to lighten without an extra battery. It therefore obtains improvement and utility. Now, accompanying with drawings, the character and structure of the present invention will be disclosed as following.

### BRIEF DESCRIPTION OF THE DRAWINGS

FIG. 1 is a perspective view of a bicycle seat cover with warning apparatus according to the present invention.

FIG. 2 is a structural diagram of the bicycle seat cover with warning apparatus of FIG. 1.

### DETAILED DESCRIPTION OF THE PREFERRED EMBODIMENT

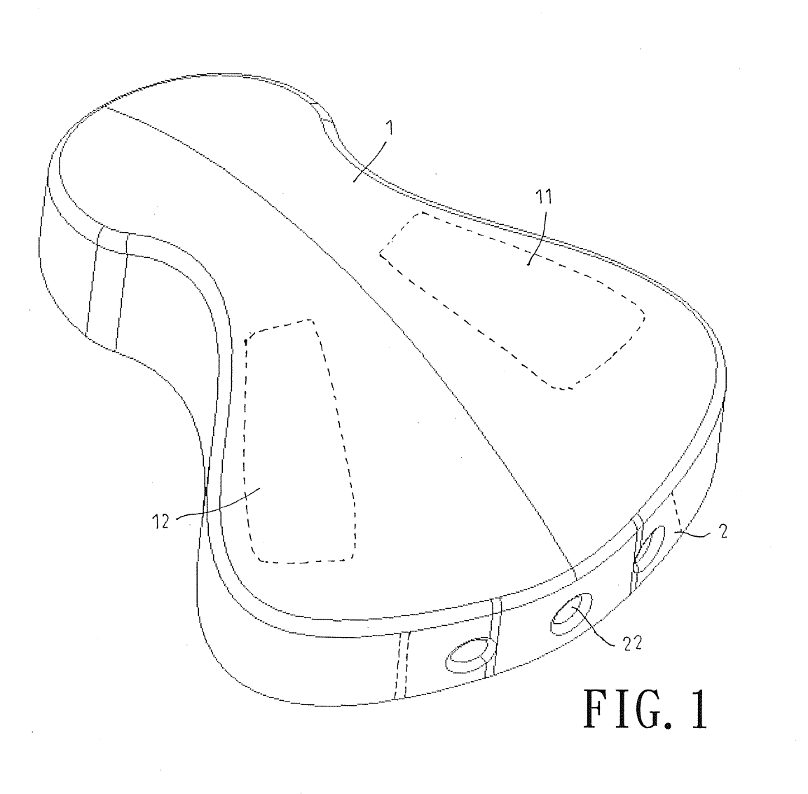

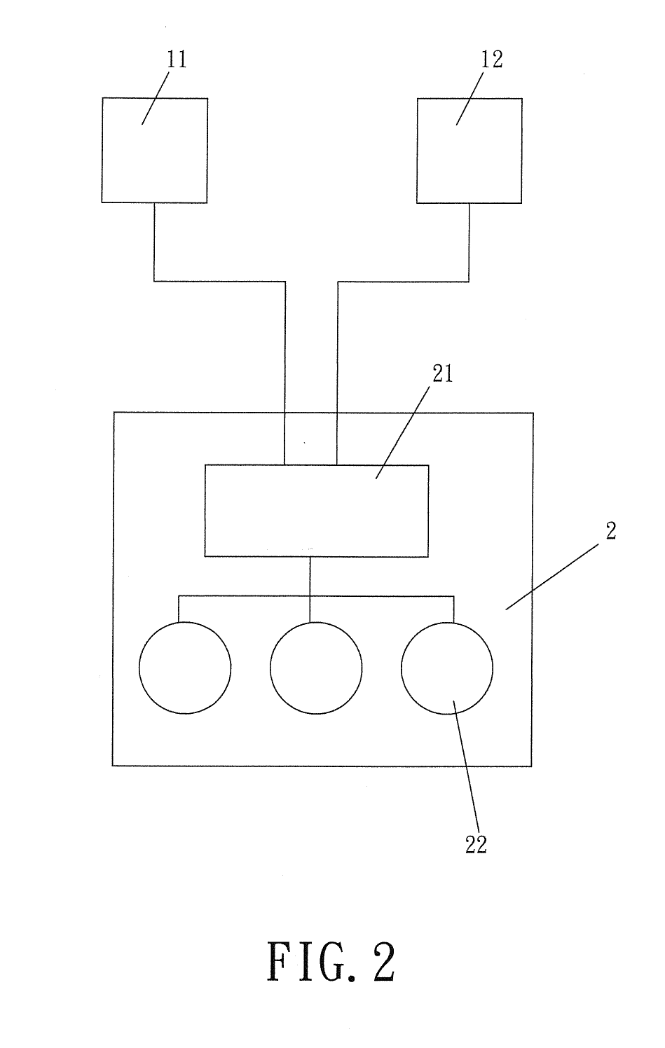

Please refer to FIGS. 1 and 2. The present invention relates to a seat cover (1) for a bicycle, which is also a warning apparatus. The figure of the seat cover can be designed to fit any kind of bicycle seat. The seat cover (1) is provided with two electricity generate modules (11) [symbol] (12) inside and an LED module (2) backside. The LED module (2) includes at least one energy transfer circuit (21) and at least one LED (22), in this example three. The LEDs (22) are placed at backside direction. The electricity generate modules (11) [symbol] (12) are connected to the energy transfer circuit (21) individually.

While usage, the seat cover (1) can cover on a bicycle seat directly in ease. When a user is riding the bicycle, he put his weight on the seat cover (1) as well as on the electricity generate module (11) or (12) back and forth. So, the electricity generate module (11) [symbol] (12) can produce energy under passing reactive signal to energy transfer circuit (21) to provide the LEDs (22) to lighten. As long as the user is riding, the produced energy by electricity generate module (11) [symbol] (12) can keep the LEDs to lighten always for warning those behind the riding.

Above all, the present invention can be used easily for any rider and any kind of bicycle directly. A battery is no more necessary. Therefore, the present invention obviously obtains improvement and facilitates. And it is to be understood that any modified design according to the merit of the present invention will be still claimed in this application.

I claim:

1. A bicycle seat cover with warning apparatus provided with at least one electricity generate module inside and an LED module backside, wherein the LED module includes at least one energy transfer circuit and at least one LED, and the LED being placed at backside direction, and the electricity generate module connected to the energy transfer circuit individually.

2. The bicycle seat cover with warning apparatus as claimed in claim 1, wherein the energy transfer circuit receives signal from electricity generate module to produce energy for the LED to lighten.
